(19) United States
(12) Patent Application Publication
(10) Pub. No.: US 2008/0301559 A1
(43) Pub. Date: Dec. 4, 2008

(54) User Interface That Uses a Task Respository

(75) Inventors: Ronald R. Martinsen, Sammamish, WA (US); Taleb Tewfik Zeghmi, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/755,941

(22) Filed: May 31, 2007

(51) Int. Cl. G06F 3/00

(52) U.S. Cl. 715/710

(57) ABSTRACT

In aspects, object types are placed in a task repository and controls register with the task repository for notification when a different object type is selected. When a different object type is selected, the task repository is notified of the object type. In response, the task repository determines a list of one or more tasks associated with the selected object type. The task repository then notifies controls that have registered for notification and passes the list of one or more tasks. Using the list and the information included in the tasks, controls may rebuild their portion of a user interface. When a user or process indicates that the actions associated with an element are to be performed, the element calls the task repository and indicates a task to perform. In response, the task repository executes the actions associated with the task.

### BACKGROUND

When developing a user interface, it is quite common to have menus, toolbars, buttons, links, and other user interface elements. There are conditions in which a user interface element should be enabled or not or applicable or not. These conditions may depend on what the user has selected, for example. It is common for each user interface element to include code to determine whether it should be enabled or applicable. The code may be duplicated in many elements that are associated with the same actions. For example, a menu may have a menu item that allows a user to delete a file, while a toolbar item may have a button that allows a user to delete a file. From a developer's standpoint, this code is hard to maintain and update. When the user interface is changed, it is easy to have bugs creep into the code as the developer may forget to change code in all the affected user elements.

### SUMMARY

Briefly, aspects of the subject matter described herein relate using a task repository in conjunction with a user interface. In aspects, object types are placed in a task repository and controls register with the task repository for notification when a different object type is selected. When a different object type is selected, the task repository is notified of the object type. In response, the task repository determines a list of one or more tasks associated with the selected object type. The task repository then notifies controls that have registered for notification and passes the list of one or more tasks. Using the list and the information included in the tasks, controls may rebuild their portion of a user interface. When a user or process indicates that the actions associated with an element are to be performed, the element calls the task repository and indicates a task to perform. In response, the task repository executes the actions associated with the task.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram of an exemplary user interface window in accordance with aspects of the subject matter described herein;

FIG. 3 is a block diagram that generally represents a mechanism for allowing elements to be dynamically displayed and actions to be executed from multiple elements in accordance with aspects of the subject matter described herein;

FIG. 4 is a block diagram that represents an exemplary device configured to operate in accordance with aspects of the subject matter described herein; and

FIGS. 5-6 are flow diagrams that generally represent exemplary actions that may occur in accordance with aspects of the subject matter described herein.

### DETAILED DESCRIPTION

### Exemplary Operating Environment

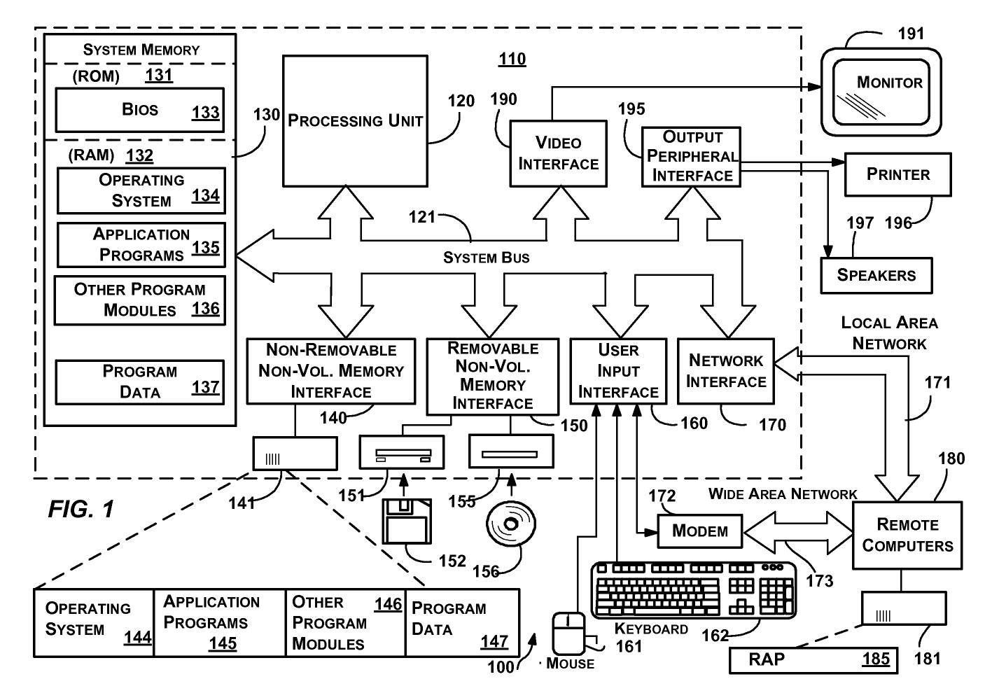

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### User Interface and Task Repository

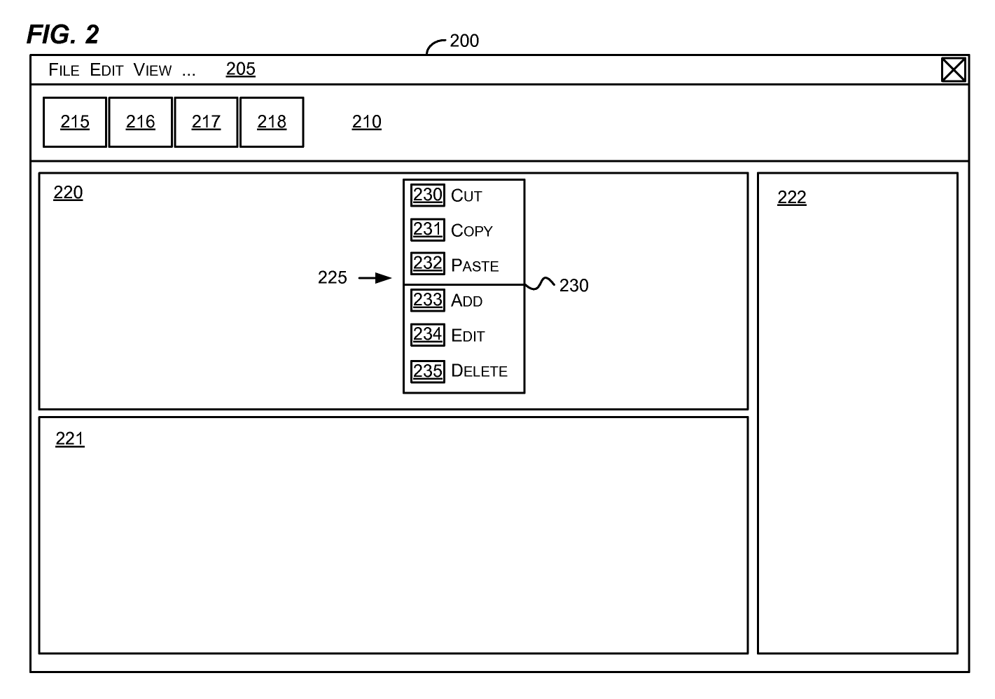

As mentioned previously, a user interface may have many components that allow a user to interact with a computer. FIG. 2 is a block diagram of an exemplary user interface window in accordance with aspects of the subject matter described herein. In one example, the window 200 may include a menu 205, a toolbar 210, panes 220-217, and user context menu 225, which are each components of the user interface.

In general, a component (sometimes called controls or elements) may be composed of zero or more other components. For example, a component may include zero or more other components which may include zero or more other components and so forth. Furthermore, it will be recognized, that the window 200 may have more, fewer, or other components which may be configured in a variety of ways without departing from the spirit or scope of the subject matter described herein.

As shown in FIG. 2, the menu 205 may include menu items such a file, edit, view, and other menu items as desired. Selecting a menu item may cause a submenu to appear which provides additional menu items to select from. Menu items in a submenu may cause additional submenus to appear and so forth. A menu item may also be associated with code to execute when the menu item is clicked or otherwise activated. This code may call a task as described in more detail below.

The toolbar 210 may include toolbar items 215-218. A toolbar item may display an image such as a bitmap or the like within it and may change visualization state to indicate that the toolbar item has been pressed or released. A toolbar item may be associated with code to execute when the toolbar item is clicked or otherwise activated. This code may call a task as described in more detail below.

The panes 220-222 may include additional user interface elements including text, buttons, grids, tool bars, list boxes, list box items, combo boxes, buttons, text, graphics, panels, additional menus, submenus, menu items, other user interface elements, and the like.

In some configurations, some panes may be devoted to displaying information about entities while one or more other panes are devoted to displaying actions that may be taken with respect to the pane that has focus. For example, one pane may be devoted to displaying information about users. This pane may display information about users such as their names, e-mail addresses, logon name, telephone number, job title, and the like.

Another pane may be devoted to displaying information about groups. For example, the pane may display group name (e.g., accounting, all staff, office location, print staff, marketing, engineering, and the like), group type (e.g., distribution list group, security group, contracting group, etc.), description (e.g., a text description of the group), and member information.

Yet another pane may be devoted to displaying additional information about a selected user or group. For a selected user, the pane may include, for example, the user's full name, the groups the user is a member of, account information such as expiration, disk quota, and so forth, mailbox size limit, file storage redirection information, and the like.

Another pane may be devoted to displaying what actions may be taken with respect to a selected user or group. For example, the pane may list items that allow a system administrator to add a new user, change user account properties, add the user to a security or distribution group, add the users to another groups (e.g., marketing, sales, engineering, etc.), remove the user, disable/enable the user account, change the user password, and the like.

It will be recognized that the above-described functions of panes is exemplary and that other functions and more or fewer panes may be used in other applications without departing from the spirit or scope of aspects of the subject matter described herein.

A context menu, such as context menu 225, may appear when a user right clicks on an entity or presses a context menu button on a keyboard, for example. The context menu 225 may provide additional options that are available with respect to a selected element. The options displayed by a context menu 225 may differ depending on which element is selected. The context menu 225 may be divided into one or more groups of actions by one or more lines 230 or some other visual indicators, for example. Items in the context menu 225 may be associated with images 230-235.

Many elements within the window 200 may be intended to perform the same actions. For example, the menu 205 may have a menu item that allows a file to be saved. The toolbar 210 may have a toolbar item 215 that allows the file to be saved. An element on one of the panes 220-222 may also provide this functionality. In addition, a context menu and/or shortcut key may also allow a file to be saved.

Furthermore, the elements that are applicable may vary based on context. For example, when a user is selecting users in the pane 220, one set of elements may be applicable, while when a user is selecting a group in a second pane another set of elements may be applicable. Some elements may need to be hidden or displayed or disabled or enabled based on the context of the user interface or the state of the selected element.

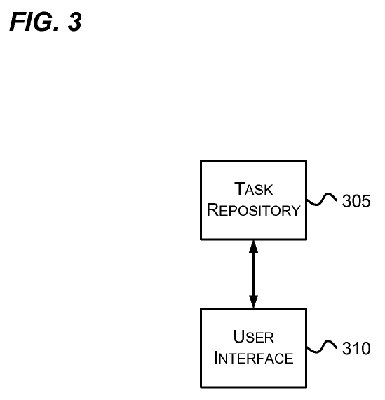

FIG. 3 is a block diagram that generally represents a mechanism for allowing elements to be dynamically displayed and actions to be executed from multiple elements in accordance with aspects of the subject matter described herein. The mechanism includes a task repository 305 and a user interface 310. The user interface 310 may include code to display elements. For example, the user interface 310 may include code to display the window 200 described in conjunction with FIG. 2.

The task repository 305 may store tasks. A task may include methods and data. In a task, the methods provide an interface which can be called to perform actions (e.g., business logic) on a given object type. The data may be used by controls in displaying one or more elements associated with the task.

The task repository 305 may be implemented in a variety of ways without departing from the spirit or scope of aspects of the subject matter described herein. For example, the task repository 305 may be implemented as a lookup table that is accessed by a process. In another example, the task repository 305 may be implemented in a database. In yet another example, the task repository 305 may be implemented as an extensible language markup (XML) file or some other file.

A task may support one or more object types. For example, a delete task for a directory service may be able to delete a user, a printer, a computer object, and other objects associated with the directory service. As another example, an object type may include a file or directory. An object type may be purely logical. Even a task may be an object type.

Having a task as an object type may provide useful benefits. For example, when executing, a task repository can be notified that it is selected and when completed the task repository may be notified that it is no longer selected. In this manner subscribers can be notified when a task is being executed. This mechanism may be used to implement a status bar which subscribes to tasks to perform, to currently executing task object types, or even to previously executed task object types. The status bar may display controls that allow undoing a previously completed task, displaying information on an executing task, canceling executing task, and so forth. There may also be a mechanism for viewing historical data on executed tasks.

In general, an object type may represent a real-world type (e.g., plants, animals, people, networks, buildings, computer users, soccer players, other types, and the like), a computer object type (which is often, but not always, based on a real-world type), and the like. Instances of an object type have certain features, attributes, and/or properties in common. For example, a person object type may include properties that people have such as height and weight.

In addition to performing an action on an object, a task may also support other actions such as undo, for example.

A task may implement one or more task information classes which describe how information associated with the task may be displayed in a user interface. For example, the task may include a task name (e.g., Delete) in a human-readable format that is localized for the country. A task may also include one or more icons (e.g., a red X image) that may be displayed via various controls. The task may include the features it supports (e.g., execute, undo, etc.) and the controls (e.g., menu, context menu, task pane, toolbar, and so forth) in which it is to be displayed. In addition, the task may include its state (e.g., enabled, disabled, and so forth), and any other metadata. Furthermore, the task may include a key pair which indicates the object type is supports and a task identifier by which it may be executed.

In one embodiment, a task may be split into task information and actions. Task information may be included in multiple task information objects that are associated with the task. This may be useful when the task actions are the same but some additional context is needed. For example, a task may include actions for deleting more than one object type as described above. To provide a user interface that is customized to the particular object type, the task may look to the task information associated with the currently selected object type. For example, the task may indicate “Deleting User” or “Deleting Group” by remembering the currently selected object type and obtaining the appropriate text from an associated task information object.

A task may be registered in the task repository 305 for a given object type (e.g., a directory service user). The object type may also be registered in the task repository separately and with no association with a task. As tasks are registered to a given object type, a collection may be maintained with the repository as to what tasks are associated with a given object type.

A control (e.g., a list control, menu, toolbar, context menu, etc.) may be populated with data of one or more object types. The control is responsible for knowing which of its contained elements are of which object type. When a selection is made, the control or its contained element which was selected notifies the task repository of the type of object that has been selected as well as the data associated with the object type. In response, the task repository 305 determines which tasks are supported by the object type. After finding the tasks that are supported, the task repository 305 may then notify listeners (also known as subscribers) of the selected object type change. These listeners may include controls in the user interface 310 that have requested (e.g., subscribed to) notification of selection changes.

In one embodiment, a listener may subscribe with the task repository 305 for event notification when a current object type maintained by the task repository is selected. In sending a notification, the task repository 305 may include a list of tasks associated with the currently selected object type. The task repository knows the mapping of tasks to elements based on subscriptions and its collection of tasks. Each task includes a list of elements it supports and the logical object it is associated with.

In another embodiment, a listener may subscribe for notification for particular types of tasks. For example, tasks may include an indicator of their type (e.g., context menu, task pane, toolbar, menu, etc.). When selection changes, the task repository 305 may include in its notification to listeners just those types of tasks to which each listener has subscribed.

The code for task execution (e.g., when a toolbar button is clicked) in the user interface element can be made the same for all of the types of elements in the control (e.g., all of the toolbar buttons). For example, a clicked on toolbar item may include code that simply sends a task ID (e.g., which may be stored in a tag property of the item) to the task repository for an execution request. In the Appendix is a pseudo code example of a list control that loads users from a data store and notifies the task repository when the selection has changed. This in turn causes the task repository to notify its listeners (the tasklist and toolbar controls) to refresh their user interfaces.

As can be seen by examining the code in the Appendix, the code may be very uncluttered while still being very adaptable. Because of the way in which the tasks are able to represent information about elements and execute actions associated therewith in a centralized manner, changing contexts within a user interface is simplified. Instead of needing to maintain extensive code in each control regarding change events, each control can simply rely on the task repository to supply the control with a list of tasks that are relevant to the changed context. A control may then use this list of tasks to re-build or modify its interface to display or hide and/or enable or disable elements that apply in a particular context.

Furthermore, the code within each element is also very simplified with respect to the actions that need to be performed when the element is clicked on. In particular, this code may simply be a one-liner that calls task repository with the appropriate task ID. The task ID may be stored in a tag associated with the element. With the task ID, the repository is able to find and execute a task.

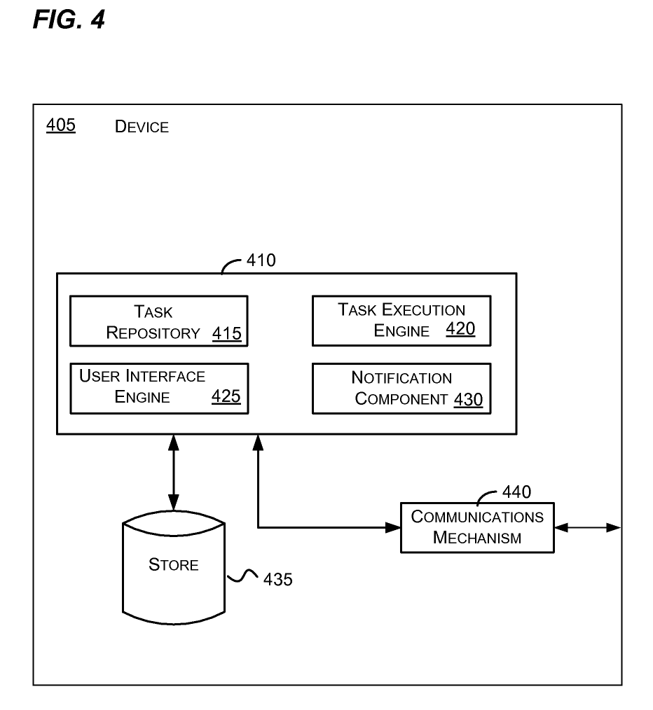

FIG. 4 is a block diagram that represents an exemplary device configured to operate in accordance with aspects of the subject matter described herein. The device 405 may include a user interface subsystem 410 that includes a task repository 415, a task execution engine 420, a user interface engine 425, and a notification component 430. The device may also include a store 435 and a communications mechanism 440.

In one embodiment each of components 415-430 may comprise one or more user or kernel-mode processes or threads thereof.

The task repository 415 receives and stores object type definitions as well as task information. Controls in the user interface may provide indications to the task repository when a particular object type is selected. In response to such an indication, the task repository 415 may store an indication of the currently selected object type and create a list of one or more tasks that are associated with the object type. After creating the list of one or more tasks that are associated with the object type, the task repository 415 may instruct the notification component 430 to notify registered controls that a different object type has been selected. In notifying the registered controls in the user interface engine 425, the notification component 430 may provide a list of one or more tasks associated with the selected object type.

Elements within the controls of the user interface engine 425 may notify the task repository 415 when a user or process (e.g., a testing script) has indicated that actions associated with the element are to be performed. In notifying the task repository 415, an element may send a task ID of a task associated with the element.

The task repository 415 may call the task execution engine 420 with the task ID and have the task execution engine 420 execute the task.

The store 435 may store identifiers of objects types, task information, and code to execute the tasks. In addition, the store 435 may store code related to user interface elements. The store 435 may comprise a file system, database, volatile memory such as RAM, other storage, some combination of the above, and the like and may be distributed across multiple devices. The data store 435 may be external or internal to the device 405.

The communications mechanism 440 allows the device 405 to communicate with other devices if needed to update elements and perform tasks related to elements, for example. The communications mechanism 440 may be a network interface or adapter 170, modem 172, or any other mechanism for establishing communications as described in conjunction with FIG. 1.

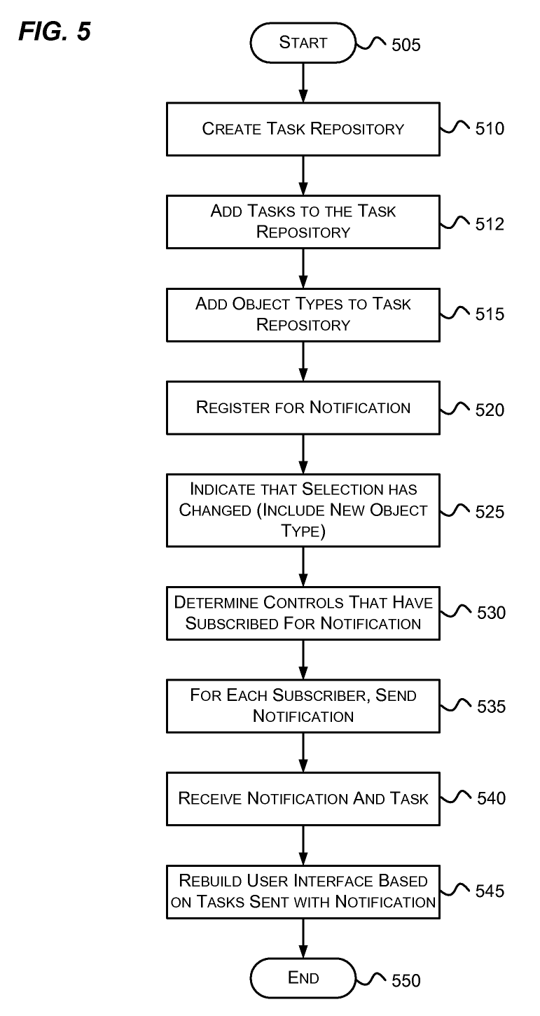

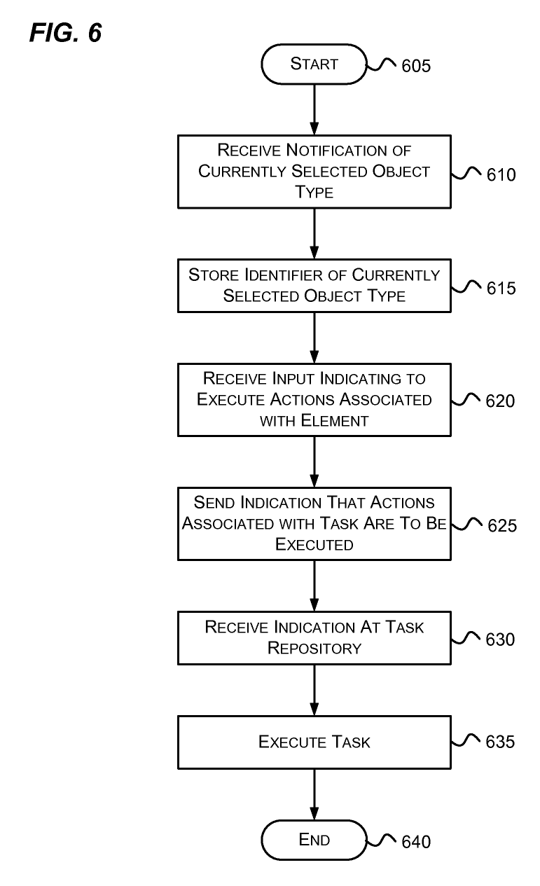

FIGS. 5-6 are flow diagrams that generally represent exemplary actions that may occur in accordance with aspects of the subject matter described herein. For simplicity of explanation, the methods described in conjunction with FIGS. 5 and 6 are depicted and described as a series of acts. It is to be understood and appreciated that the aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methods in accordance with aspects of the subject matter described herein. In addition, those skilled in the art will understand and appreciate that the methods could alternatively be represented as a series of interrelated states via a state diagram or as events.

Turning to FIG. 5, the actions begin at block 505. At block 510, a task repository is created. For example, referring to FIG. 3, the user interface 310 may instantiate a task repository 305.

At block 512, tasks are added to the task repository. In conjunction with adding a task to the task repository, code (e.g., methods) and data associated with the task may also be added to the task repository.

At block 515, object types are added to the task repository. For example, referring to FIG. 4, the user interface engine 425 may add object types to the task repository 415 by sending, for example, an object type identifier and an object type.

At block 520, one or more controls may register for notification of when a different object type has been selected. For example, referring to FIG. 4, controls within the user interface engine 425 may register for notification with the task repository 415.

At block 525, a control may indicate that selection has changed (e.g., that a different object type has been selected). In so indicating, the control may send an identifier associated with the different object type. For example, referring to FIG. 4, a control within the user interface engine 425 may send a notification to the task repository 415 when a user selects a different object type.

At block 530, a task repository may determine the controls that have subscribed for notification of when a different object type is selected. For example, referring to FIG. 4, the task repository 415 may use internal data structures to determine which controls to notify of the selection of a different object type.

At block 535, a notification is sent to each subscriber. For example, referring to FIG. 4, the task repository 415 may pass a list of tasks that are applicable to the selected object type to the notification component 430 and instruct the notification component 430 to notify each subscriber of the currently selected object type.

At block 540, a subscriber receives notification together with one or more tasks associated therewith. Using the tasks, at block 545, the subscriber (e.g., a control) determines which elements to display, hide, enable, disable, and so forth. The control uses the information in the sent one or more tasks to build the elements as described previously.

At block 550, the actions end.

Turning to FIG. 6, at block 605, the actions begin. At block 610, a task repository receives notification of a currently selected object. For example, referring to FIG. 4, the task repository 415 may receive notification that a different object type has been selected.

At block 615, the task repository stores an identifier of the currently selected object type. This is done so that the task repository may have this information if the task associated with the object type is executed as described previously.

At block 620, input is received that indicates that actions associated with an element are to be performed. For example, a user may click on a user element or a program (e.g., a testing script or other process) may instruct the element to execute the actions associated with it.

At block 625, an indication is sent that actions associated with the task are to be performed. This may be done, for example, by sending an identifier of a task to the task repository, by calling a particular method associated with the task, and the like.

At block 630, the indication is received at the task repository. For example, referring to FIG. 4, the task repository 415 receives a task identifier from an element of a user interface engine 425.

At block 635, the task is executed. The task may use the currently selected object type as stored in block 615 to act appropriately to the selected object type. For example, deleting a user may involve different actions that deleting a file.

At block 640, the actions end.

As can be seen from the foregoing detailed description, aspects have been described related to a user interface that uses a task repository. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

```
APPENDIX
// First create a task repository
TaskRepository TR = new TaskRepository( );
. . .
// Add objects to the task repository
TR.AddObject(”User”, <type of object>);
. . .
// Register for Events
TR.RegisterEventHandler(”ObjectTypeChanged”,
  Toolbar.LoadToolbarButtons);
TR.RegisterEventHandler(”ObjectTypeChanged”,
  TaskList.LoadTaskListButtons);
. . .
// Populate List Item and associate each item with an object
// type
void LoadListItems(Datasource ds)
{
    foreach(DataRow dr in ds)
    {
      ListItem li = MyList.AddItem(dr.Name);
      li.Tag = dr.TypeID;
    }
}
. . .
// Notify Task Repository when selection in list changes
void OnListSelectionChanged(ListItem liCurrent)
{
    TR.RaiseEvent(”ObjectTypeChanged”, liCurrent);
}
. . .
// Task repository calls this function when the OnTypeChanged
// event is raised
void OnTypeChangedHandler(object type)
{
    List<TaskInfo> items = GetItemsForObject(type);
    foreach(EventHandler e in ObjectTypeChangedHandlers
EventHandlers)
    {
      e.RaiseEvent(items);
    }
}
. . .
// Rebuild user interface in list control based on new selected
// element
void LoadTaskListTasks(List<TaskInfo> items)
{
    TaskList. ClearAll( );
    foreach(Taskinfo ti in items)
    {
      if(ti.Type == UIType.TaskList)
      {
        TaskListButton tb = new TaskListButton(ti.Name,
ti.Image, ti.TooltipText);
        tb.Enabled = ti.Enabled;
        tb.Tag = ti.ID;
        tb.OnClick = OnTaskListButtonClicked;
        TaskList.AddItem(tb);
      }
    }
}
// If the element is clicked, it can simply execute the task
// by calling the task object with a task ID associated with
// the element. In one embodiment, the task ID is stored in
// a tag associated with the element
void OnTaskListButtonClicked(TaskListButton button)
{
    TR.ExecuteTask((TaskId)button.tag);
}
// Rebuild user interface in list control based on new selected
// element
void LoadToolbarButtons(List<TaskInfo> items)
{
    Toolbar.ClearAll( );
    foreach(Taskinfo ti in items)
    {
      if(ti.Type == UIType.Toolbar)
      {
        ToolbarButton tb = new ToolbarButton(ti.Name,
ti.Image, ti.TooltipText);
        tb.Enabled = ti.Enabled;
        tb.Tag = ti.ID;
        tb.OnClick = OnToolbarButtonClicked;
        Toolbar.AddItem(tb);
      }
    }
}
// If the element is clicked, it can simply execute the task
// by calling the task object with a task ID associated with
// the element. In one embodiment, the task ID is stored in
// a tag associated with the element
void OnToolbarButtonClicked(ToolbarButton button)
{
    TR.ExecuteTask((TaskId)button.tag);
}
```

What is claimed is:

1. A computer-readable medium having computer-executable instructions, which when executed perform actions, comprising:
registering for notification to be provided when a different object type is selected;
receiving the notification and an indication of a task associated with the different object type, the task identifying data for use in displaying an element in the user interface; and
displaying the element based on the task.

2. The computer-readable medium of claim 1, wherein registering for notification to be provided when a different object type is selected comprises registering with a task repository that stores the task.

3. The computer-readable medium of claim 3, wherein the data for use in displaying an element in the user interface is included in the task.

4. The computer-readable medium of claim 3, wherein the data for use in displaying an element in the user interface is associated with the task.

5. The computer-readable medium of claim 1, wherein the data comprises text, an icon, and a list of one or more controls that the task supports.

6. The computer-readable medium of claim 1, wherein registering for notification to be provided when a different object type is selected comprises a control registering for notification and wherein the element is displayed via the control.

7. The computer-readable medium of claim 6, wherein the control determines using the data whether to enable or disable the element.

8. The computer-readable medium of claim 6, wherein the control determines using the data whether to display or hide the element.

9. The computer-readable medium of claim 6, wherein the control uses the data to determine features of the element.

10. The computer-readable medium of claim 1, wherein the task is associated with actions that are applicable to a plurality of elements of the user interface, wherein each of the elements when activated are coded to request that the actions be executed.

11. A method implemented at least in part by a computer, the method comprising:
receiving notification of an object type, the object type associated with a task that is stored in a repository, the task indicating a list of controls that are capable of formatting elements using information identified by the task;
storing an indication of the object type; and
receiving an indication that actions associated with the task are to be performed.

12. The method of claim 11, wherein receiving an indication that actions associated with the task are to be performed comprises receiving an identifier associated with the task sent from an element of a user interface.

13. The method of claim 12, wherein the identifier is stored in a tag of the element.

14. The method of claim 11, further comprising:
retrieving the indication of the object type; and
performing the actions on a object of the object type.

15. The method of claim 11, further comprising:
providing information about the task to a list of controls, the information indicating which elements of the controls to display.

16. In a computing environment, an apparatus, comprising:
a task repository operable to receive an indication that an object type has been selected and in response thereto to determine a list of one or more tasks associated with the object type;
a user interface engine operable to provide the indication to the task repository in response to receiving input to select the object type; and
a notification component operable to send a notification to controls within the user interface engine that the object type has changed.

17. The apparatus of claim 16, wherein the notification component is further operable to send the list of one or more tasks to the controls.

18. The apparatus of claim 17, wherein the controls are operable to use the list to display elements associated with the one or more tasks.

19. The apparatus of claim 18, wherein the controls are further operable to associate task identifiers with the elements, each element operable to provide an associated task identifier to the task repository upon indication that a task associated with the element is to be performed.

20. The apparatus of claim 16, further comprising a task execution engine operable to execute a task in response to request from an element of the user interface.
